(19) United States
(12) Patent Application Publication
(10) Pub. No.: US 2015/0280257 A1
(43) Pub. Date: Oct. 1, 2015

(54) Heater with a Fuel Cell Stack Assembly and a Combustor and Method of Operating

(71) Applicant: DELPHI TECHNOLOGIES, INC., TROY, MI (US)

(72) Inventors: BERNHARD A. FISCHER, HONEOYE FALLS, NY (US); JAMES D. RICHARDS, SPENCERPORT, NY (US)

(21) Appl. No.: 14/230,196

(22) Filed: Mar. 31, 2014

(51) Int. Cl. H01M 8/04

(52) U.S. Cl. CPC H01M 8/04022; H01M 2250/00

(57) ABSTRACT

A heater includes a heater housing; a fuel cell stack assembly within the heater housing and having a plurality of fuel cells; a combustor within the heater housing for combusting a mixture of fuel and air to form a heated combustor exhaust that is discharged into the heater housing; a combustor fuel supply conduit for supplying the fuel to the combustor; an anode exhaust conduit for communicating anode exhaust from the fuel cell stack assembly out of the heater housing; and a combustor bypass conduit in fluid communication with the combustor fuel supply conduit and the anode exhaust conduit for allowing a portion of the fuel to bypass the combustor.

### TECHNICAL FIELD OF INVENTION

The present invention relates to a heater which uses fuel cell stack assemblies as a source of heat; more particularly to such a heater which is positioned within a bore hole of an oil containing geological formation in order to liberate oil therefrom; even more particularly to such a heater which includes a combustor for combusting a mixture of fuel and air, thereby functioning as an additional source of heat and a source of heat for elevating the fuel cell stack assemblies to an active temperature upon initiation of use of the heater; and still even more particularly to a method for operating the heater.

### BACKGROUND OF INVENTION

Subterranean heaters have been used to heat subterranean geological formations in oil production, remediation of contaminated soils, accelerating digestion of landfills, thawing of permafrost, gasification of coal, as well as other uses. Some examples of subterranean heater arrangements include placing and operating electrical resistance heaters, microwave electrodes, gas-fired heaters or catalytic heaters in a bore hole of the formation to be heated. Other examples of subterranean heater arrangements include circulating hot gases or liquids through the formation to be heated, whereby the hot gases or liquids have been heated by a burner located on the surface of the earth. While these examples may be effective for heating the subterranean geological formation, they may be energy intensive to operate.

U.S. Pat. Nos. 6,684,948 and 7,182,132 propose subterranean heaters which use fuel cells as a more energy efficient source of heat. The fuel cells are disposed in a heater housing which is positioned within the bore hole of the formation to be heated. The fuel cells convert chemical energy from a fuel into heat and electricity through a chemical reaction with an oxidizing agent. U.S. Pat. No. 7,182,132 teaches that in order to start operation of the heater, an electric current may be passed through the fuel cells in order to elevate the temperature of the fuel cells sufficiently high to allow the fuel cells to operate, i.e. an electric current is passed through the fuel cells before the fuel cells are electrically active. While passing an electric current through the fuel cells may elevate the temperature of the fuel cells, passing an electric current through the fuel cells before the fuel cells are electrically active may be harsh on the fuel cells and may lead to a decreased operational life thereof.

U.S. patent application Ser. No. 14/081,068 to Fischer et al., the disclosure of which is incorporated herein by reference in its entirety, teaches a subterranean heater which uses fuel cells and combustors to heat a geological formation. The fuel cells and combustors are disposed in a heater housing in an alternating pattern and are operated to heat the heater housing, and consequently the geological formation. In addition to heating the geological formation, the combustors are used to elevate the temperature of the fuel cells to their active temperature. While the arrangement of Fisher et al. may be effective, it may be difficult to decrease the thermal output of the combustors as may be desirable after the fuel cells have reached their active temperature.

What is needed is a heater which minimizes or eliminates one of more of the shortcomings as set forth above.

### SUMMARY OF THE INVENTION

A heater is provided which permits adjustment to the output of a combustor of the heater while allowing the combustor to share a fuel supply conduit and an air supply conduit with a fuel cell stack assembly of the heater. The heater includes a heater housing extending along a heater axis; a fuel cell stack assembly disposed within the heater housing and having a plurality of fuel cells which convert chemical energy from a fuel into heat and electricity through a chemical reaction with an oxidizing agent, the fuel cell stack assembly having 1) a fuel cell stack fuel inlet for introducing the fuel to a plurality of anodes of the plurality of fuel cells, 2) a fuel cell stack oxidizing agent inlet for introducing the oxidizing agent to a plurality of cathodes of the plurality of fuel cells, 3) an anode exhaust outlet for discharging an anode exhaust comprising unspent fuel from the plurality of fuel cells, and 4) a cathode exhaust outlet for discharging a cathode exhaust comprising unspent fuel cell oxidizing agent from the plurality of fuel cells; a combustor disposed within the heater housing for combusting a mixture of the fuel and the oxidizing agent to form a heated combustor exhaust, the combustor having 1) a combustor fuel inlet for introducing the fuel into the combustor, 2) a combustor oxidizing agent inlet for introducing the oxidizing agent into the combustor, and 3) a combustor exhaust outlet for discharging the heated combustor exhaust from the combustor into the heater housing; a combustor fuel supply conduit for supplying the fuel to the combustor fuel inlet; a combustor fuel supply conduit for supplying the fuel to the combustor fuel inlet; an anode exhaust conduit connected to the anode exhaust outlet and extending out of the heater housing for communicating the anode exhaust out of the heater housing; and a combustor bypass conduit in fluid communication with the combustor fuel supply conduit and the anode exhaust conduit for allowing a portion of the fuel to bypass the combustor. The heater housing is heated by the fuel cell stack assembly and also by the heated combustor exhaust and the combustor bypass conduit allows the thermal output of the combustor to be varied.

A method of operating a heater is provided where the heater includes a heater housing extending along a heater axis; a fuel cell stack assembly disposed within the heater housing and having a plurality of fuel cells which convert chemical energy from a fuel into heat and electricity through a chemical reaction with an oxidizing agent, the fuel cell stack assembly having 1) a fuel cell stack fuel inlet for introducing the fuel to a plurality of anodes of the plurality of fuel cells, 2) a fuel cell stack oxidizing agent inlet for introducing the oxidizing agent to a plurality of cathodes of the plurality of fuel cells, 3) an anode exhaust outlet for discharging an anode exhaust comprising unspent fuel from the plurality of fuel cells, and 4) a cathode exhaust outlet for discharging a cathode exhaust comprising unspent fuel cell oxidizing agent from the plurality of fuel cells; a combustor disposed within the heater housing for combusting a mixture of the fuel and the oxidizing agent to form a heated combustor exhaust, the combustor having 1) a combustor fuel inlet for introducing the fuel into the combustor, 2) a combustor oxidizing agent inlet for introducing the oxidizing agent into the combustor, and 3) a combustor exhaust outlet for discharging the heated combustor exhaust from the combustor into the heater housing. The method includes supplying the fuel to the combustor fuel inlet using a combustor fuel supply conduit, communicating the anode exhaust out of the heater housing using an anode exhaust conduit connected to the anode exhaust outlet and extending out of the heater housing, and allowing a portion of the fuel to bypass the combustor using a combustor bypass conduit in fluid communication with the combustor fuel supply conduit and the anode exhaust conduit.

### BRIEF DESCRIPTION OF DRAWINGS

This invention will be further described with reference to the accompanying drawings in which:

FIG. 1 is a schematic of a heater in accordance with the present invention;

FIG. 2 is a schematic of a plurality of heaters of FIG. 1 shown in a bore hole of a geological formation;

FIG. 3 is a schematic of a fuel cell stack assembly of the heater of FIG. 1;

FIG. 4 is a schematic of a fuel cell of the fuel cell stack assembly of FIG. 3; and

FIG. 5 is a schematic of a combustor of the heater of FIG. 1.

### DETAILED DESCRIPTION OF INVENTION

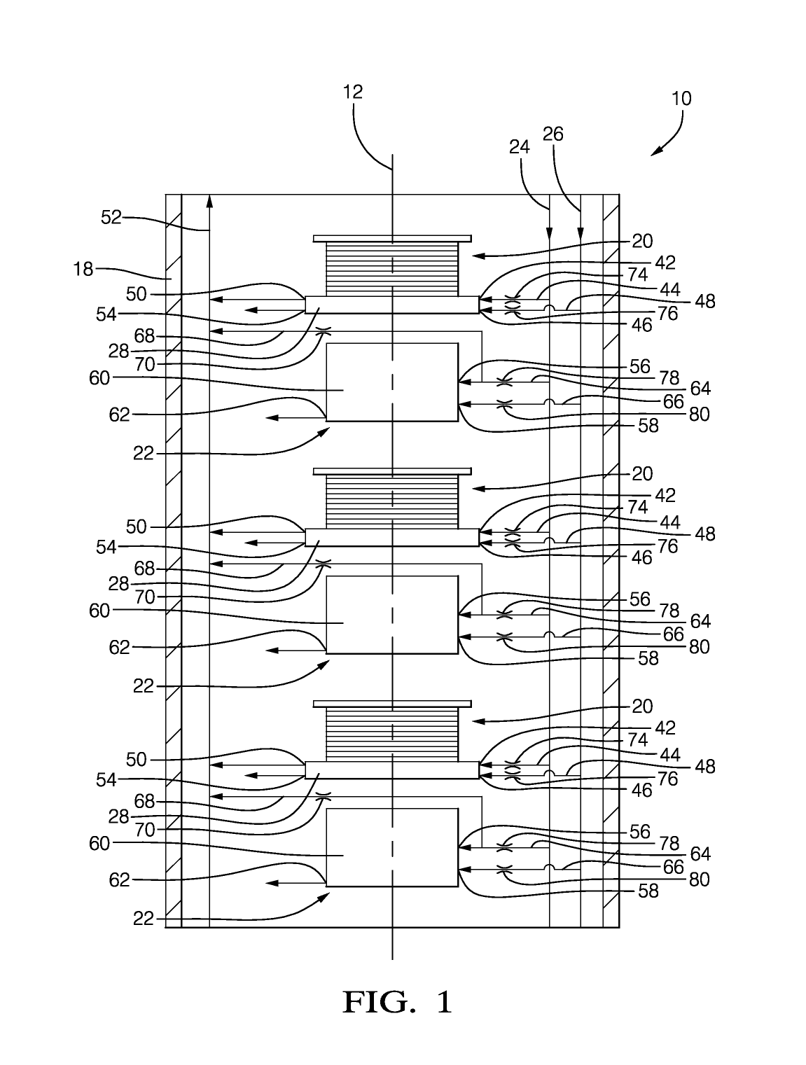

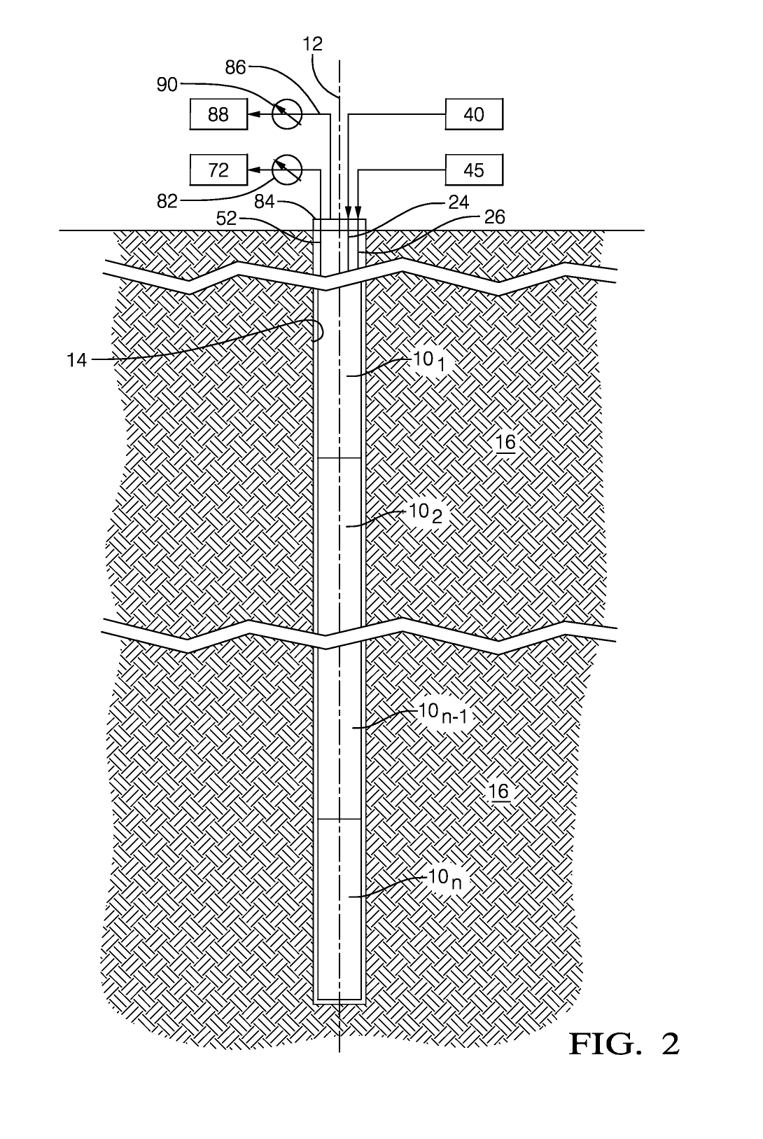

Referring now to FIGS. 1 and 2, a heater 10 extending along a heater axis 12 is shown in accordance with the present invention. A plurality of heaters 10₁, 10₂, . . . 10ₙ₋₁, 10ₙ, where n is the total number of heaters 10, may be connected together end to end within a bore hole 14 of a formation 16, for example, an oil containing geological formation, as shown in FIG. 2. Bore hole 14 may be only a few feet deep; however, may typically be several hundred feet deep to in excess of one thousand feet deep. Consequently, the number of heaters 10 needed may range from one to several hundred. It should be noted that the oil containing geological formation may begin as deep as one thousand feet below the surface and consequently, heater 10₁ may be located sufficiently deep within bore hole 14 to be positioned near the beginning of the oil containing geological formation. When this is the case, units without active heating components may be positioned from the surface to heater 10₁ in order to provide plumbing, power leads, and instrumentation leads to support and supply fuel and air to heaters 10₁ to 10ₙ.

Heater 10 generally includes a heater housing 18 extending along heater axis 12, a plurality of fuel cell stack assemblies 20 located within heater housing 18 such that each fuel cell stack assembly 20 is spaced axially apart from each other fuel cell stack assembly 20, a plurality of combustors 22 located within heater housing 18 such that combustors 22 and fuel cell stack assemblies 20 are arranged in an alternating pattern, a fuel supply conduit 24 for supplying fuel to fuel cell stack assemblies 20 and combustors 22, and an oxidizing agent supply conduit 26; hereinafter referred to as air supply conduit 26; for supplying an oxidizing agent, for example air, to fuel cell stack assemblies 20 and combustors 22. While heater 10 is illustrated with three fuel cell stack assemblies 20 and three combustors 22 within heater housing 18, it should be understood that a lesser number or a greater number of fuel cell stack assemblies 20 and/or combustors 22 may be included. The number of fuel cell stack assemblies 20 within heater housing 18 may be determined, for example only, by one or more of the following considerations: the length of heater housing 18, the heat output capacity of each fuel cell stack assembly 20, the desired density of fuel cell stack assemblies 20 and/or combustors 22 (i.e. the number of fuel cell stack assemblies 20 and/or combustors 22 per unit of length), and the desired heat output of heater 10. The number of heaters 10 within bore hole 14 may be determined, for example only, by one or more of the following considerations: the depth of formation 16 which is desired to be heated, the location of oil within formation 16, and the length of each heater 10.

Heater housing 18 may be substantially cylindrical and hollow and may support fuel cell stack assemblies 20 and combustors 22 within heater housing 18. Heater housing 18 of heater 10ₓ, where x is from 1 to n where n is the number of heaters 10 within bore hole 14, may support heaters 10ₓ₊₁ to 10ₙ by heaters 10ₓ₊₁ to 10ₙ hanging from heater 10ₓ. Consequently, heater housing 18 may be made of a material that is substantially strong to accommodate the weight of fuel cell stack assemblies 20 and heaters 10ₓ₊₁ to 10ₙ. The material of heater housing 18 may also have properties to withstand the elevated temperatures, for example 600° C. to 900° C., as a result of the operation of fuel cell stack assemblies 20 and combustors 22. For example only, heater housing 18 may be made of a 300 series stainless steel with a wall thickness of 3/16 of an inch.

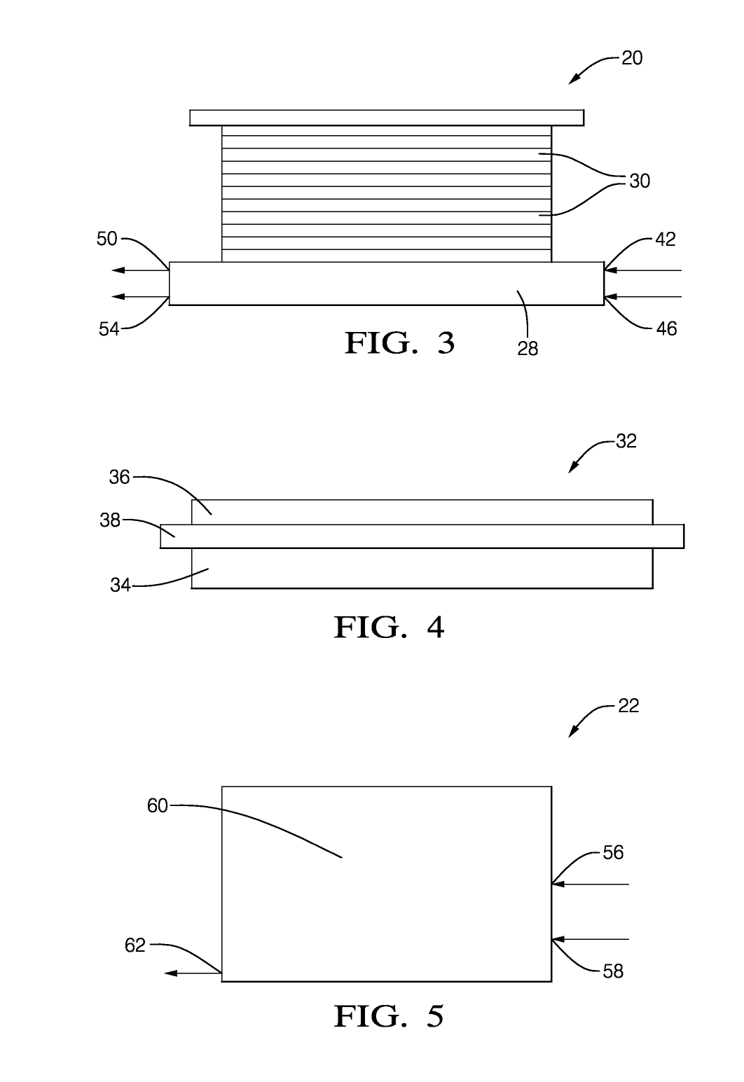

With continued reference to FIGS. 1 and 2 and now with additional reference to FIGS. 3 and 4, fuel cell stack assemblies 20 may be, for example only, solid oxide fuel cells which generally include a fuel cell manifold 28 and a plurality of fuel cell cassettes 30 (for clarity, only select fuel cell cassettes 30 have been labeled). Each fuel cell stack assembly 20 may include, for example only, 20 to 50 fuel cell cassettes 30.

Each fuel cell cassette 30 includes a fuel cell 32 having an anode 34 and a cathode 36 separated by a ceramic electrolyte 38. Each fuel cell 32 converts chemical energy from a fuel supplied to anode 34 into heat and electricity through a chemical reaction with air supplied to cathode 36. Fuel cell cassettes 30 have no electrochemical activity below a first temperature, for example, about 500° C., and consequently will not produce heat and electricity below the first temperature. Fuel cell cassettes 30 have a very limited electrochemical activity between the first temperature and a second temperature; for example, between about 500° C. and about 700° C., and consequently produce limited heat and electricity between the first temperature and the second temperature, for example only, about 0.01 kW to about 3.0 kW of heat (due to the fuel self-igniting above about 600° C.) and about 0.01 kW to about 0.5 kW electricity for a fuel cell stack assembly having thirty fuel cell cassettes 30. When fuel cell cassettes 30 are elevated above the second temperature, for example, about 700° C. which is considered to be the active temperature, fuel cell cassettes 30 are considered to be active and produce desired amounts of heat and electricity, for example only, about 0.5 kW to about 3.0 kW of heat and about 1.0 kW to about 1.5 kW electricity for a fuel cell stack assembly having thirty fuel cell cassettes 30. Further features of fuel cell cassettes 30 and fuel cells 32 are disclosed in United States Patent Application Publication No. US 2012/0094201 to Haltiner, Jr. et al. which is incorporated herein by reference in its entirety.

Now again with reference to FIGS. 1 and 2, fuel cell manifold 28 receives fuel and distributes the fuel to each fuel cell cassette 30. The fuel, e.g. a hydrogen rich reformate, may be supplied to fuel cell manifold 28 from a fuel reformer 40 through a fuel cell fuel inlet 42 via fuel supply conduit 24 and a fuel cell fuel supply conduit 44 which connects fuel supply conduit 24 to fuel cell fuel inlet 42. Fuel cell manifold 28 also receives an oxidizing agent and distributes the oxidizing agent to each fuel cell cassette 30. The oxidizing agent, e.g. air, may be supplied to fuel cell manifold 28 from an air supply 45 through a fuel cell air inlet 46 via air supply conduit 26 and a fuel cell air supply conduit 48 which connects air supply conduit 26 to fuel cell air inlet 46. Fuel cell manifold 28 also receives anode exhaust, i.e. spent fuel and excess fuel from fuel cells 32 which may comprise H₂, CO, H₂O, CO₂, and N₂, and discharges the anode exhaust from fuel cell manifold 28 through an anode exhaust outlet 50 which is in fluid communication with an anode exhaust return conduit 52 as will be discussed in greater detail later. Fuel cell manifold 28 also receives cathode exhaust, i.e. spent air and excess air from fuel cells 32 which may comprise O₂ (depleted compared to the air supplied through air supply conduit 26) and N₂, and discharges the cathode exhaust from fuel cell manifold 28 through a cathode exhaust outlet 54 into heater housings 18.

With continued reference to FIGS. 1 and 2 and now with additional reference to FIG. 5, each combustor 22 may include a combustor fuel inlet 56, a combustor oxidizing agent inlet 58; hereinafter referred to as combustor air inlet 58, a combustion chamber 60, and a combustor exhaust outlet 62. Each combustor 22 may receive fuel through combustor fuel inlet 56 via fuel supply conduit 24 and a combustor fuel supply conduit 64 which connects fuel supply conduit 24 to combustor fuel inlet 56. Each combustor 22 may also receive air through combustor air inlet 58 via air supply conduit 26 and a combustor air supply conduit 66 which connects air supply conduit 26 to combustor air inlet 58. The fuel and air that are supplied to each combustor 22 are mixed within combustion chamber 60 to form a combustible mixture which is combusted to form a heated combustor exhaust. The heated combustor exhaust is discharged from combustor 22 through combustor exhaust outlet 62 into heater housing 18.

Again with reference to FIGS. 1 and 2, a combustor bypass conduit 68 is provided in fluid communication with combustor fuel supply conduit 64 and anode exhaust return conduit 52 in order to bypass a portion of the fuel around combustor 22. Combustor bypass conduit 68 may include a restrictor 70 therein in order to provide a predetermined pressure loss through combustor bypass conduit 68. Combustor bypass conduit 68 will be discussed in greater detail later.

In use, heaters 10₁, 10₂, . . . 10ₙ₋₁, 10ₙ are operated by supplying fuel and air to fuel cell stack assemblies 20 which are located within heater housing 18. Fuel cell stack assemblies 20 carry out a chemical reaction between the fuel and air, causing fuel cell stack assemblies 20 to be elevated in temperature, for example, about 600° C. to about 900° C. Anode exhaust from fuel cell stack assemblies 20 is sent to anode exhaust return conduit 52 while cathode exhaust from fuel cell stack assemblies 20 is discharged into heater housing 18. Anode exhaust return conduit 52 communicates the anode exhaust out of heaters 10, e.g. out of bore hole 14, where the anode exhaust may be utilized by an anode exhaust utilization device 72 which may be used, for example only, to produce steam, drive compressors, or supply a fuel reformer. Fuel and air is supplied to combustors 22 where the fuel and the air is mixed and combusted to form a heated combustor exhaust which is discharged into heater housing 18. Consequently, fuel cell stack assemblies 20 together with the heated combustor exhaust elevate the temperature of heater housing 18 which subsequently elevates the temperature of formation 16.

When heaters 10₁, 10₂, . . . 10ₙ₋₁, 10ₙ are connected together in sufficient number and over a sufficient distance, the pressure of fuel at fuel cell stack assemblies 20 may vary along the length of heaters 10₁, 10₂, . . . 10ₙ₋₁, 10ₙ. This variation in the pressure of fuel may lead to varying fuel flow to fuel cell stack assemblies 20 that may not be compatible with desired operation of each fuel cell stack assembly 20. In order to obtain a sufficiently uniform flow of fuel to each fuel cell stack assembly 20, a sonic fuel cell fuel orifice 74 may be provided between fuel supply conduit 24 and fuel cell cassettes 30. As shown, sonic fuel cell fuel orifice 74 is located in fuel cell fuel supply conduit 44, however, it should be understood that other locations may be chosen, for example, in fuel cell manifold 28. Sonic fuel cell fuel orifice 74 is sized to create a pressure differential between the fuel pressure upstream thereof and the fuel pressure downstream thereof such that the ratio of the fuel pressure upstream of sonic fuel cell fuel orifice 74 to the fuel pressure downstream of sonic fuel cell fuel orifice 74 is at least 1.85:1 which is known as the critical pressure ratio. When the critical pressure ratio is achieved at each sonic fuel cell fuel orifice 74, the velocity of fuel through each sonic fuel cell fuel orifice 74 will be the same and will be held constant as long as the ratio of the fuel pressure upstream of sonic fuel cell fuel orifice 74 to the fuel pressure downstream of sonic fuel cell fuel orifice 74 is at least 1.85:1. Since the velocity of fuel through each sonic fuel cell fuel orifice 74 is equal, the flow of fuel to each fuel cell stack assembly 20 will be sufficiently the same for desired operation of each fuel cell stack assembly 20. The density of the fuel may vary along the length of heaters 10₁, 10₂, . . . 10ₙ₋₁, 10ₙ due to pressure variation within fuel supply conduit 24, thereby varying the mass flow of fuel to each fuel cell stack assembly 20; however, the variation in pressure within fuel supply conduit 24 is not sufficient to vary the mass flow of fuel to each fuel cell stack assembly 20 to an extent that would not be compatible with desired operation of each fuel cell stack assembly 20.

Similarly, when heaters 10₁, 10₂, . . . 10ₙ₋₁, 10ₙ are connected together in sufficient number and over a sufficient distance, the pressure of air at fuel cell stack assemblies 20 may vary along the length of heaters 10₁, 10₂, . . . 10ₙ₋₁, 10ₙ. This variation in the pressure of air may lead to varying air flow to fuel cell stack assemblies 20 that may not be compatible with desired operation of each fuel cell stack assembly 20. In order to obtain a sufficiently uniform flow of air to each fuel cell stack assembly 20, a sonic fuel cell air orifice 76 may be provided between air supply conduit 26 and fuel cell cassettes 30. As shown, sonic fuel cell air orifice 76 is located in fuel cell air supply conduit 48, however, it should be understood that other locations may be chosen, for example, in fuel cell manifold 28. Sonic fuel cell air orifice 76 is sized to create a pressure differential between the air pressure upstream thereof and the air pressure downstream thereof such that the ratio of the air pressure upstream of sonic fuel cell air orifice 76 to the air pressure downstream of sonic fuel cell air orifice 76 is at least 1.85:1 which is known as the critical pressure ratio. When the critical pressure ratio is achieved at each sonic fuel cell air orifice 76, the velocity of air through each sonic fuel cell air orifice 76 will be the same and will be held constant as long as the ratio of the air pressure upstream of sonic fuel cell air orifice 76 to the air pressure downstream of sonic fuel cell air orifice 76 is at least 1.85:1. Since the velocity of air through each sonic fuel cell air orifice 76 is equal, the flow of air to each fuel cell stack assembly 20 will be sufficiently the same for desired operation of each fuel cell stack assembly 20. The density of the air may vary along the length of heaters 10₁, 10₂, . . . 10ₙ₋₁, 10ₙ due to pressure variation within air supply conduit 26, thereby varying the mass flow of air to each fuel cell stack assembly 20; however, the variation in pressure within air supply conduit 26 is not sufficient to vary the mass flow of air to each fuel cell stack assembly 20 to an extent that would not be compatible with desired operation of each fuel cell stack assembly 20.

Similarly, when heaters 10₁, 10₂, . . . 10ₙ₋₁, 10ₙ are connected together in sufficient number and over a sufficient distance, the pressure of fuel at combustors 22 may vary along the length of heaters 10₁, 10₂, . . . 10ₙ₋₁, 10ₙ. This variation in the pressure of fuel may lead to varying fuel flow to combustors 22 that may not be compatible with desired operation of each combustor 22. In order to obtain a sufficiently uniform flow of fuel to each combustor 22, a sonic combustor fuel orifice 78 may be provided between fuel supply conduit 24 and combustion chamber 60. As shown, sonic combustor fuel orifice 78 is located in combustor fuel supply conduit 64 upstream of combustor bypass conduit 68, however, it should be understood that other locations may be chosen. Sonic combustor fuel orifice 78 is sized to create a pressure differential between the fuel pressure upstream thereof and the fuel pressure downstream thereof such that the ratio of the fuel pressure upstream of sonic combustor fuel orifice 78 to the fuel pressure downstream of sonic combustor fuel orifice 78 is at least 1.85:1 which is known as the critical pressure ratio. When the critical pressure ratio is achieved at each sonic combustor fuel orifice 78, the velocity of fuel through each sonic combustor fuel orifice 78 will be the same and will be held constant as long as the ratio of the fuel pressure upstream of sonic combustor fuel orifice 78 to the fuel pressure downstream of sonic combustor fuel orifice 78 is at least 1.85:1. Since the velocity of fuel through each sonic combustor fuel orifice 78 is equal, the flow of fuel to each combustor 22 will be sufficiently the same for desired operation of each combustor 22. The density of the fuel may vary along the length of heaters 10₁, 10₂, . . . 10ₙ₋₁, 10ₙ due to pressure variation within fuel supply conduit 24, thereby varying the mass flow of fuel to each combustor 22; however, the variation in pressure within fuel supply conduit 24 is not sufficient to vary the mass flow of fuel to each combustor 22 to an extent that would not be compatible with desired operation of each combustor 22.

Similarly, when heaters 10₁, 10₂, . . . 10ₙ₋₁, 10ₙ are connected together in sufficient number and over a sufficient distance, the pressure of air at combustors 22 may vary along the length of heaters 10₁, 10₂, . . . 10ₙ₋₁, 10ₙ. This variation in the pressure of air may lead to varying air flow to combustors 22 that may not be compatible with desired operation of each combustor 22. In order to obtain a sufficiently uniform flow of air to each combustor 22, a sonic combustor air orifice 80 may be provided between air supply conduit 26 and combustion chamber 60. As shown, sonic combustor air orifice 80 is located in combustor air supply conduit 66; however, it should be understood that other locations may be chosen. Sonic combustor air orifice 80 is sized to create a pressure differential between the air pressure upstream thereof and the air pressure downstream thereof such that the ratio of the air pressure upstream of sonic combustor air orifice 80 to the air pressure downstream of sonic combustor air orifice 80 is at least 1.85:1 which is known as the critical pressure ratio. When the critical pressure ratio is achieved at each sonic combustor air orifice 80, the velocity of air through each sonic combustor air orifice 80 will be the same and will be held constant as long as the ratio of the air pressure upstream of sonic combustor air orifice 80 to the air pressure downstream of sonic combustor air orifice 80 is at least 1.85:1. Since the velocity of air through each sonic combustor air orifice 80 is equal, the flow of air to each combustor 22 will be sufficiently the same for desired operation of each combustor 22. The density of the air may vary along the length of heaters 10₁, 10₂, . . . 10ₙ₋₁, 10ₙ due to pressure variation within air supply conduit 26, thereby varying the mass flow of air to each combustor 22; however, the variation in pressure within air supply conduit 26 is not sufficient to vary the mass flow of air to each combustor 22 to an extent that would not be compatible with desired operation of each combustor 22.

An anode exhaust valve 82 is provided in anode exhaust return conduit 52 in order to adjustably restrict flow through anode exhaust return conduit 52, and consequently also adjustably restrict flow through anode exhaust outlets 50 and combustor bypass conduit 68. When anode exhaust valve 82 is operated to provide a greater restriction in anode exhaust return conduit 52, the flow of fuel through combustor bypass conduit 68 will be decreased which results in an increased flow of fuel to combustors 22 which increases the thermal output of combustors 22. This may be particularly useful for initiating operation of heaters 10 since fuel cell stack assemblies 20 must be elevated to their active temperature before they can produce heat. Conversely, when anode exhaust valve 82 is operated to provide lesser restriction in anode exhaust return conduit 52, the flow of fuel through combustor bypass conduit 68 will be increased which results in a decreased flow of fuel to combustors 22 which decreases the thermal output of combustors 22. This may be particularly useful when fuel cell stack assemblies 20 have reached their active temperature and are producing sufficient thermal output to adequately heat formation 16, thereby allowing reduced thermal output from combustors 22.

A collector 84 may be provided to collect the cathode exhaust and combustor exhaust that has been discharged into heater housings 18 from fuel cell stack assemblies 20 and combustors 22. Collector 84 may be provided at the surface of formation 16 and communicates the cathode exhaust and combustor exhaust to a cathode exhaust conduit 86 which is in fluid communication with a cathode exhaust utilization device 88 which uses the cathode exhaust and the combustor exhaust. Cathode exhaust utilization device 88 may be, for example only, a heat exchanger, a condenser, or a combustor. A cathode exhaust valve 90 is provided in cathode exhaust conduit 86 for adjustably restricting the cathode exhaust and the combustor exhaust through cathode exhaust conduit 86. When anode exhaust valve 82 is used to provide a greater restriction in anode exhaust return conduit 52, a back pressure is created on anodes 34 of fuel cell stack assemblies 20. If the pressure differential between anodes 34 and cathodes 36 is sufficiently high, damage may occur to fuel cell cassettes 30 which may result in undesirable operation of fuel cell stack assemblies 20. Consequently, it may be desirable to use cathode exhaust valve 90 to provide a greater restriction in cathode exhaust conduit 86 in order to pressure balance fuel cell stack assemblies 20. In this way, the pressure differential between anodes 34 and cathodes 36 of fuel cell stack assemblies 20 can be maintained in a safe operating rage which is not detrimental to fuel cell cassettes 30.

While this invention has been described in terms of preferred embodiments thereof, it is not intended to be so limited, but rather only to the extent set forth in the claims that follow.

We claim:

1. A heater comprising:
a heater housing extending along a heater axis;
a fuel cell stack assembly disposed within said heater housing and having a plurality of fuel cells which convert chemical energy from a fuel into heat and electricity through a chemical reaction with an oxidizing agent, said fuel cell stack assembly having 1) a fuel cell stack fuel inlet for introducing said fuel to a plurality of anodes of said plurality of fuel cells, 2) a fuel cell stack oxidizing agent inlet for introducing said oxidizing agent to a plurality of cathodes of said plurality of fuel cells, 3) an anode exhaust outlet for discharging an anode exhaust comprising unspent fuel from said plurality of fuel cells, and 4) a cathode exhaust outlet for discharging a cathode exhaust comprising unspent fuel cell oxidizing agent from said plurality of fuel cells;
a combustor disposed within said heater housing for combusting a mixture of said fuel and said oxidizing agent to form a heated combustor exhaust, said combustor having 1) a combustor fuel inlet for introducing said fuel into said combustor, 2) a combustor oxidizing agent inlet for introducing said oxidizing agent into said combustor, and 3) a combustor exhaust outlet for discharging said heated combustor exhaust from said combustor into said heater housing;
a combustor fuel supply conduit for supplying said fuel to said combustor fuel inlet;
an anode exhaust conduit connected to said anode exhaust outlet and extending out of said heater housing for communicating said anode exhaust out of said heater housing; and
a combustor bypass conduit in fluid communication with said combustor fuel supply conduit and said anode exhaust conduit for allowing a portion of said fuel to bypass said combustor;
whereby said heater housing is heated by said fuel cell stack assembly and also by said heated combustor exhaust.

2. A heater as in claim 1 further comprising an anode exhaust valve in said anode exhaust conduit for adjustably restricting said anode exhaust and said portion of said fuel through said anode exhaust conduit;
whereby increasing restriction through said anode exhaust conduit with said anode exhaust valve causes said portion of said fuel to decrease, thereby increasing said fuel supplied to said combustor; and
whereby decreasing restriction through said anode exhaust conduit with said anode exhaust valve causes said portion of said fuel to increase, thereby decreasing said fuel supplied to said combustor.

3. A heater as in claim 2 wherein said cathode exhaust outlet discharges said cathode exhaust into said heater housing; said heat further comprising a collector for communicating said cathode exhaust and said heated combustor exhaust from said heater housing to a cathode exhaust conduit.

4. A heater as in claim 3 further comprising a cathode exhaust valve in said cathode exhaust conduit for adjustably restricting said cathode exhaust and said heated combustor exhaust through said cathode exhaust conduit in order to pressure balance said fuel cell stack assembly.

5. A combustor as in claim 1 further comprising a restrictor in said combustor bypass conduit for providing a predetermined pressure loss through said combustor bypass conduit.

6. A combustor as in claim 1 further comprising a fuel supply conduit which supplies said fuel to said fuel cell stack assembly and to said combustor fuel supply conduit.

7. A combustor as in claim 6 further comprising a sonic orifice disposed between said fuel supply conduit and said combustor fuel inlet and adapted to achieve a critical pressure ratio, thereby limiting the velocity of said fuel.

8. A combustor as in claim 7 wherein said combustor bypass conduit is in fluid communication with said combustor fuel supply conduit between said sonic orifice and said combustor fuel inlet.

9. A method for operating a heater comprising a heater housing extending along a heater axis; a fuel cell stack assembly disposed within said heater housing and having a plurality of fuel cells which convert chemical energy from a fuel into heat and electricity through a chemical reaction with an oxidizing agent, said fuel cell stack assembly having 1) a fuel cell stack fuel inlet for introducing said fuel to a plurality of anodes of said plurality of fuel cells, 2) a fuel cell stack oxidizing agent inlet for introducing said oxidizing agent to a plurality of cathodes of said plurality of fuel cells, 3) an anode exhaust outlet for discharging an anode exhaust comprising unspent fuel from said plurality of fuel cells, and 4) a cathode exhaust outlet for discharging a cathode exhaust comprising unspent fuel cell oxidizing agent from said plurality of fuel cells; a combustor disposed within said heater housing for combusting a mixture of said fuel and said oxidizing agent to form a heated combustor exhaust, said combustor having 1) a combustor fuel inlet for introducing said fuel into said combustor, 2) a combustor oxidizing agent inlet for introducing said oxidizing agent into said combustor, and 3) a combustor exhaust outlet for discharging said heated combustor exhaust from said combustor into said heater housing, said method comprising:
supplying said fuel to said combustor fuel inlet using a combustor fuel supply conduit;
communicating said anode exhaust out of said heater housing using an anode exhaust conduit connected to said anode exhaust outlet and extending out of said heater housing; and
allowing a portion of said fuel to bypass said combustor using a combustor bypass conduit in fluid communication with said combustor fuel supply conduit and said anode exhaust conduit.

10. A method as in claim 9 further comprising adjustably restricting said anode exhaust and said portion of said fuel through said anode exhaust conduit;
whereby increasing restriction through said anode exhaust conduit causes said portion of said fuel to decrease, thereby increasing said fuel supplied to said combustor; and
whereby decreasing restriction through said anode exhaust conduit causes said portion of said fuel to increase, thereby decreasing said fuel supplied to said combustor.

11. A method as in claim 10 wherein said step of adjustably restricting said anode exhaust and said portion of said fuel includes using an anode exhaust valve in said anode exhaust conduit.

12. A method as in claim 10 further comprising:
discharging said cathode exhaust into said heater housing; and
communicating said cathode exhaust and said heated combustor exhaust from said heater housing to a cathode exhaust conduit.

13. A method as in claim 12 further comprising adjustably restricting said cathode exhaust and said heated combustor exhaust through said cathode exhaust conduit in order to pressure balance said fuel cell stack assembly.

14. A method as in claim 13 wherein said step of adjustably restricting said cathode exhaust and said heated combustor exhaust comprises using a cathode exhaust valve in said cathode exhaust conduit.

15. A method as in claim 9 further comprising using a restrictor in said combustor bypass conduit for providing a predetermined pressure loss through said combustor bypass conduit.

16. A method as in claim 9 further comprising supplying said fuel to said fuel cell stack assembly and to said combustor fuel supply conduit using a fuel supply conduit.

17. A method as in claim 16 further comprising using a sonic orifice disposed between said fuel supply conduit and said combustor fuel inlet to achieve a critical pressure ratio, thereby limiting the velocity of said fuel.

18. A combustor as in claim 17 wherein said combustor bypass conduit is in fluid communication with said combustor fuel supply conduit between said sonic orifice and said combustor fuel inlet.
